(19) United States
(12) Patent Application Publication
(10) Pub. No.: US 2021/0064512 A1
(43) Pub. Date: Mar. 4, 2021

(54) SELECTIVE MEMORY TRACING OF PROGRAM EXECUTION

(71) Applicant: VEEGO SOFTWARE LTD., Ramat Gan (IL)

(72) Inventors: Denis SIROV, Tel Aviv (IL); Amir KOTLER, Rishon Lezion (IL); Reffael CASPI, Tel Aviv (IL)

(21) Appl. No.: 16/551,946

(22) Filed: Aug. 27, 2019

(51) Int. Cl. G06F 11/36; G06F 9/30

(52) U.S. Cl. CPC G06F 11/3636; G06F 9/30058

(57) ABSTRACT

A system comprising: at least one hardware processor; and a non-transitory computer-readable storage medium having stored thereon program commands, the program commands executable by the at least one hardware processor to: receive a sequence of computer program instructions, analyze the received sequence of program instructions to indicate execution points associated with non-deterministic program instructions, execute the sequence of computer program instructions while capturing program state data, wherein said program state data is associated with at least some of said indicated execution points, and, generate a replay of said execution, wherein said generating comprises inserting said captured program state data at said associated execution points.

### FIELD OF THE INVENTION

The invention generally related to the field of computer products and computer systems.

### BACKGROUND OF THE INVENTION

A trace is a sequence of logged information that indicates what events (e.g., instruction executions) have occurred while a program is running. Trace techniques are often used to collect runtime information from a workload to monitor and log every instruction executed by the computer system. The logged execution traces may then be useful for, e.g., debugging, fault tolerance, and performing various simulations. However, conventional trace collection systems typically use techniques that incur high runtime overhead, as trace detail increases.

The foregoing examples of the related art and limitations related therewith are intended to be illustrative and not exclusive. Other limitations of the related art will become apparent to those of skill in the art upon a reading of the specification and a study of the figures.

### SUMMARY OF THE INVENTION

The following embodiments and aspects thereof are described and illustrated in conjunction with systems, tools and methods which are meant to be exemplary and illustrative, not limiting in scope.

There is provided, in an embodiment, a system comprising: at least one hardware processor; and a non-transitory computer-readable storage medium having stored thereon program code, the program code executable by the at least one hardware processor to: receive a sequence of computer program instructions, analyze the received sequence of program instructions to indicate execution points associated with non-deterministic program instructions, execute the sequence of computer program instructions while capturing program state data, wherein said program state data is associated with at least some of said indicated execution points, and generate a replay of said execution, wherein said generating comprises inserting said captured program state data at said associated execution points.

There is also provided, in an embodiment, a method comprising: receiving a sequence of computer program instructions; analyzing the received sequence of program instructions to indicate execution points associated with non-deterministic program instructions; executing the sequence of computer program instructions while capturing program state data, wherein said program state data is associated with at least some of said indicated execution points; and generating a replay of said execution, wherein said generating comprises inserting said captured program state data at said associated execution points.

There is further provided in an embodiment, a computer program product comprising a non-transitory computer-readable storage medium having program code embodied therewith, the program code executable by at least one hardware processor to: receive a sequence of computer program instructions; analyze the received sequence of program instructions to indicate execution points associated with non-deterministic program instructions; execute the sequence of computer program instructions while capturing program state data, wherein said program state data is associated with at least some of said indicated execution points; and generate a replay of said execution, wherein said generating comprises inserting said captured program state data at said associated execution points.

In some embodiments, said capturing further comprises storing said captured program state data in an event log, and wherein said inserting comprises accessing said event log to retrieve said captured program state data.

In some embodiments, said analyzing further comprises indicating execution points associated with deterministic program instructions, and wherein said generating further comprises executing said execution points associated with said deterministic program instructions.

In some embodiments, said indicating further comprises creating an index of all said indications.

In some embodiments, said program state data comprises at least some of: content of at least some processor registers, memory content, variables utilized in the execution time, variable values, a symbol map, calls made by the execution, program stack content, and a program heap content.

In some embodiments, said indicating further comprises identifying, for each of said execution points, all preceding execution points that are conditional branch instructions associated therewith.

In some embodiments, the program code is further executable to generate, and the method further comprises generating, a partial replay from a specified execution point, wherein said partial replay comprises executing all said preceding execution points.

In addition to the exemplary aspects and embodiments described above, further aspects and embodiments will become apparent by reference to the figures and by study of the following detailed description.

### BRIEF DESCRIPTION OF THE FIGURES

Exemplary embodiments are illustrated in referenced figures. Dimensions of components and features shown in the figures are generally chosen for convenience and clarity of presentation and are not necessarily shown to scale. The figures are listed below.

FIG. 1 illustrates a computing system, in accordance with exemplary embodiments of the present invention;

FIG. 2A illustrates a computer operable method designed to perform a computerized process involved with selective memory tracing for capturing the program states and write the captured snapshots to a trace log, according to exemplary embodiments of the present invention, and;

FIG. 2B illustrates a computer operable method for performing a replay of an execution instance by utilizing a trace log, according to exemplary embodiments of the present invention.

### DETAILED DESCRIPTION OF THE INVENTION

Disclosed herein are a computer system, method and computer program product, designed to perform automated selective memory tracing of an execution flow of a computer program, which allow for the subsequent replay of all or part of the execution flow, in a way that is logically equivalent to an original execution of interest.

In some embodiments of the present invention, the replayed execution flow may be used to reproduce the program state at any point in time during execution, e.g., for debugging and/or archival purposes.

As used herein, the term “replay” refers to a replaying of a recorded execution of a computer program. Generally, during replay, the program code is re-executed while being supplied with the traced memory and register values, which causes the program to re-execute in substantially the same manner that it did when it was traced—including reproducing the same memory state, processor register state, etc., at discrete points in time.

In some embodiments of the present invention, at a preliminary analysis stage, the method disclosed herein can be operated on a received sequence of computer program instructions. The method disclosed herein may analyze the received computer program instructions to identify one or more instructions or a block of instructions as, e.g., either ‘deterministic’ or ‘non-deterministic,’ based, at least in part, on whether the program state resulting from the execution thereof can be identified on the basis of the preliminary analysis, prior to actual execution.

As used herein, a ‘deterministic’ program instruction, function, and/or event, refers to an instruction, function, and/or event, the effect of whose execution can be calculated prior to its execution. Accordingly, a program state resulting from the execution of a deterministic instruction can be calculated and/or determined solely on the basis of an advance analysis of the code, without the need for any actual execution of the instruction. In some embodiments, deterministic program instructions include those instructions, such as ‘move’ instructions which copy a memory content, whose resulting program state can be calculated when executed on a known current memory space.

Conversely, ‘non-deterministic’ instruction, function, and/or event refers to an instruction, function, and/or event, the effect of whose execution cannot be calculated prior to its execution. Accordingly, non-deterministic program instructions require an actual execution to determine a post-execution program state, because, e.g., the execution involves accessing external links to, e.g., modules, libraries, sets of instructions, and/or binary files.

Examples of sources of non-determinism in computer program execution include, but are not limited to, I/O, e.g., user input, programmatic timers, asynchronous callbacks, thread context switching, direct memory access (DMA) timing, shared memory access, and interrupts. A source of non-determinism in the form of user input may include input from a keyboard, mouse, joystick, or other device, which varies in timing and in value across different sessions of use of a program. Non-deterministic input from programmatic timers includes any query to a system clock that a program performs. Asynchronous callbacks are considered non-deterministic because it is not possible to predict when callbacks will arrive for tasks that a program has “handed off” to an operating system routine or to another program. For example, the operating system may require a different amount of time to perform such tasks depending on network conditions, resource conditions, etc. Thread context switching is non-deterministic because the time at which a CPU switches from executing one thread to another is not readily predictable, so that the order of operations performed by multiple threads may vary, and therefore the path of execution in code may vary among execution sessions. DMA timing is non-deterministic because the state of system main memory can change between successive program accesses to the memory if system hardware performs intervening DMA accesses. Shared memory access is a source of non-determinism because multiple threads may set values in shared memory at different times without informing the application under test. Interrupt routines are potential sources of non-determinism, and therefore interrupt routines are trapped and replayed.

In some embodiments of the present invention, the analysis process can be a computerized process involving a combination of machine commands, processor instructions processing a set of digital inputs, and the like, to interpret whether a received instruction or set of instructions are deterministic or non-deterministic. In some cases, as disclosed herein, the analysis process can take place in an analysis stage, wherein one or multiple computerized processes such as analysis process, defining process, and the like are performed.

As used herein, the term “program state” refers to the content of a series of memory storage locations at any given point in the program's execution. The content may be stored as variables or constants whose states may change as the program is executed. Examining the state of a program can be used as a testing method or a way of analyzing the code base. The memory storage locations may be processor registers, such as the program counter or instruction pointer register, and/or the status register.

The program state information stored in the memory structure can comprise, e.g., the variables utilized in the execution time, the variable values, the symbol map, calls made by the program, the program stack, the program heap, and the like. The program state can also comprise information required to continue the execution flow, wherein the execution flow depicts a sequence of the computer instructions which are being executed. Thus, the information required to continue the execution flow can comprise memory links, call backs, the return values, object names in multiple threads, and the like. In some cases, e.g., in cases of utilizing a software program designed to execute code by providing an execution environment for that code, the program state can comprise Live-Object.

As used herein, the term “computer program instruction” or “program instruction” refers to executable and/or interpretable processor instructions. In some cases, the sequence of program instructions can be a binary code representing machine-language instructions designed to be executed by a digital processor. For example, the binary code can be provided by an executable file, (e.g., with the suffix .EXE) complied to represent machine-language instructions. In some other cases, the sequence of program instructions can also be provided in an interpreted language which can be executed by utilizing an interpreter. In such cases, the program instructions can appear directly and freely in a script, without previously compiling the computer instructions into machine-language instructions. A sequence of program instructions can comprise one or more versions of a software application. In some embodiments, program instructions can be in the form of bytecode (also termed portable code or p-code), such as Java, which is a form of instruction set designed for efficient execution by a software interpreter. In some cases, a sequence of program instructions can be comprised of a plurality of executable and/or interpretable files. In some other cases, a sequence of program instructions can also include module, libraries, and binary files. The sequence of program instructions can also comprise interfaces with a plurality of other software applications.

In some embodiments, the present disclosure provides for automated selective memory tracing during an execution flow of the sequence of program instructions, based, at least in part, on the preliminary analysis and defining process. In some embodiments, the selective memory tracing captures program state snapshots with their associated execution points, in case these program states result from execution of computer program instructions identified as non-deterministic. In some embodiments, the selective memory tracing process does not capture a full program state at execution points associated with non-deterministic instructions. For example, in some cases, only partial program state data is captured, wherein the captured data includes only those elements of the program state associated with and/or corresponding to the execution of non-deterministic instructions. In some embodiments of the present invention, program state data resulting from deterministic program instructions may not to be captured. In some cases, program state data resulting from execution of deterministic program instructions can be later inserted during replay, e.g., by a simple re-execution of the program instruction.

As used herein, the term “snapshot” refers to a record or a copy of the structure and the content of a memory at a particular point in time during the execution. In general, a full memory snapshot stores a record of all memory addresses and values known at the time of the snapshot. A differential memory snapshot stores a record of any memory addresses and values that have changed or been discovered since the prior memory snapshot (whether that be a full memory snapshot or a differential memory snapshot).

In some cases, it can refer to an actual copy of all or a specified portion of the memory state of a computer program during an execution of at least a part of a computer program. In some embodiments, program state data or snapshots may collect various program states at the execution time. For example, the program state snapshot can comprise local and global variable values, source code related to the executing code, and other information.

In some embodiments of the present invention, the selective memory tracing may allow for subsequent partial or full replaying of the execution flow in a controlled and managed fashion. In some embodiments of the present invention, the selective memory tracing can be conducted during the execution flow of the analyzed program instructions. In such cases, the selective memory tracing comprises executing at least a portion of the received program instructions.

In some embodiments of the present invention, the selective memory tracing comprises a snapshotting process of at least some of the program states and associated execution points resulting from the execution flow. In some embodiments of the present invention, the snapshotting process can be configured to only capture the program states in cases where the executed program instructions are identified as non-deterministic. In such cases, the captured snapshots and execution points can also undergo a writing process wherein the snapshots and execution points, or at least a part thereof, can be written or copied to a trace log.

In some embodiments of the present invention, upon completion of the snapshot writing process to the trace log, a replay stage is configured to replay the execution flow of the received sequence of program instructions. In some embodiments, the replay of the execution flow may comprise (i) re-executing deterministic program instructions, and (ii) injecting the logged non-deterministic program states, to create the complete execution flow.

In some cases, such an injection of logged program states can involve inserting a logged program state associated with a non-deterministic program instruction during the execution flow replay, at an execution point identified and/or marked and/or indexed as associated with that program instruction.

For example, in an instance of an execution, a computer program instruction or a block of program instructions is executed. Then, during the replay of the execution flow, content related to the program state resulting from the execution of that computer program instruction or block of program instructions is injected, to recreate a program state associated with an execution point thereof in the execution flow. In such an exemplary case, the execution flow can continue further with the injected content and an actual call for the computer program instruction or block of program instructions may not be performed.

In some embodiments of the present invention, the replay process can execute at least a portion of the program instructions by executing them according to the received sequence of program instructions. The replay process can also execute at least a portion of the program instructions, by injecting the snapshotted program states from the trace log to the memory space of the replayed execution flow at the associated execution points.

A potential advantage of the present disclosure is, therefore, in that it can provide the ability to generate a partial or complete replay of an execution flow of a computer program, e.g., for debugging purposes, without the need for full tracing of every program state during execution. The present disclosure thus provides for reduced usage of memory and computational resources, as well as a reduced impact on the execution of the program during the tracing.

In some embodiments of the present invention, there is provided a mechanism to control the replay of the execution flow. In such embodiments, control functionalities may be associated with the marked and/or indexed program instructions. In some cases, the control functionalities can be, but are not limited to, debugging processes, wherein the computer system can provide control functionalities over the replayed execution flow.

In some cases, the control functionalities can be, e.g., stopping the replay of the execution flow, reviewing the program's variable values during the replay of the execution flow, replaying the execution flow starting from one specific location in the execution flow up to another specific location in the execution flow, and the like.

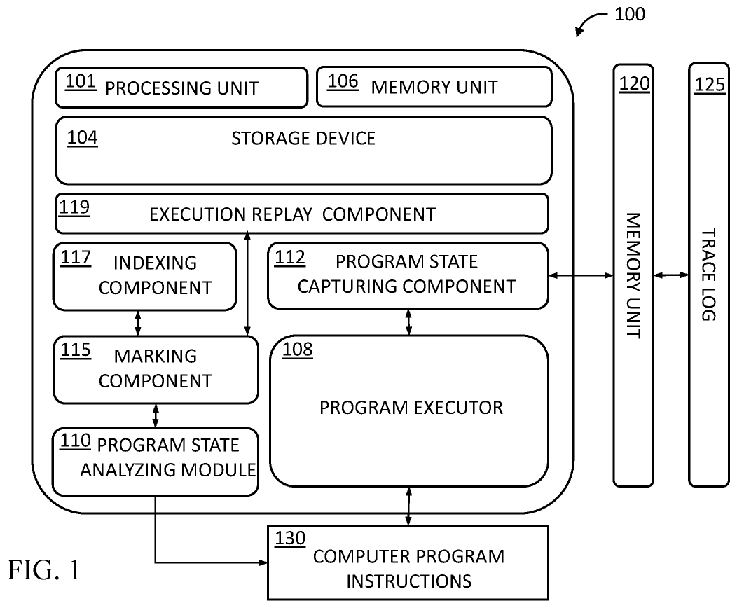

FIG. 1 illustrates an exemplary computing system 100 in accordance with exemplary embodiments of the present invention. In some embodiments, system 100 is designed and configured to receive a sequence of program instructions, such as sequence of program instructions 130, and automatically perform a selective snapshotting process of the program state during the execution flow of the sequence 130.

The computing system 100 can operate by utilizing a processing unit 101 which can comprise one or more hardware processors, and a computer-readable storage device, such as memory unit 106 coupled to the one or more processors of the processing unit 101. System 100 as described herein is only an exemplary embodiment of the present invention, and in practice may be implemented in hardware only, software only, or a combination of both hardware and software. System 100 may have more or fewer components and modules than shown, may combine two or more of the components, or may have a different configuration or arrangement of the components. In various embodiments, system 100 may comprise one or more dedicated hardware devices, one or more software modules, and/or may form an addition to or extension to an existing device.

The memory unit 106 may comprise instructions which when executed by the one or more processors, cause the one or more processors to perform various ones of, and combinations of, the operations outlined above regarding the computing system 100 embodiment. The computer system 100 can introduce functions which can include a plurality of services, functions, tasks, and programs utilized to perform the perform a selective snapshotting process and the execution flow replay of at least some of instructions in the sequence of computer program instructions 130.

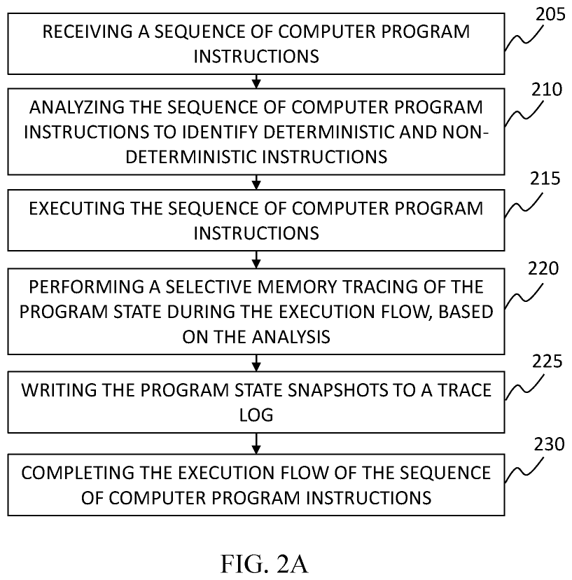

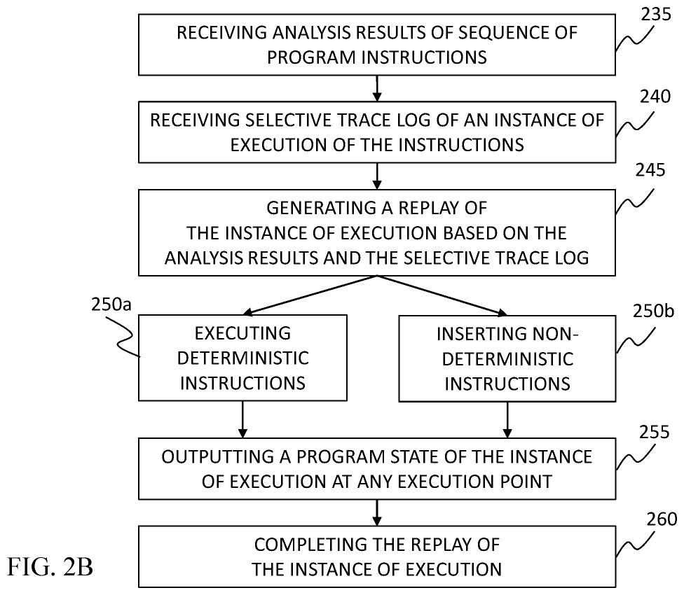

Exemplary functional steps in a process for automated selective memory tracing of an execution flow of a computer program, according to the present disclosure, will now be described with reference to the flowcharts in FIG. 2A.

In some embodiments, at step 205, program state analyzing module 110 may be configured to receive a sequence of program instructions, to identify instructions and/or blocks of instructions within sequence 130 as either deterministic or non-deterministic. In some cases, the sequence of computer program instructions can be received by a memory address directing to a location or locations in a computer readable storage medium. In some other cases, the received sequence of computer program instructions can be received by a dedicated interface of a software application.

In some embodiments, at step 210 the sequence of computer program instructions is analyzed to identify computer program instructions as either deterministic or non-deterministic.

In one example, the program state resulting from execution of a computer program instruction can comprise information related to the program stack, the program heap, the symbol map, the variables utilized in the execution time, calls made, and the like.

In some cases, the program state analyzing module 110 can be configured to identify a program instruction as either deterministic or non-deterministic, namely, whether a program state resulting from the execution thereof can be calculated, determined, and/or reproduced from an analysis of the computer program instruction given a known current memory space, without the need for actual execution of the instruction. In some embodiments, the program state analyzing module 110 can be configured to identify a computer program instruction wherein the program state resulting from the execution thereof is non-deterministic, namely cannot be derived and/or understood and/or predicted from an analysis of the computer program instructions.

For example, the program state analyzing module 110 can analyze at least a portion of the computer instructions of the sequence of computer program instructions 130 and, solely based on that analysis, identify a program instruction as either deterministic or non-deterministic.

In some cases, a group or groups of computer instructions can be identified by the computer system 100 as a program block, or program blocks. A program block can be defined as a program construct comprising computer instructions which can be executed by a processing unit in order, without breaking that order, namely without preforming an exit or jump to another memory location of another computer instruction set. For example, such a jump to another memory location can be caused by a conditional event which forces the processing unit to break the execution order.

One exemplary case for computer program instructions wherein the program state resulting from the execution thereof is non-deterministic, is instructions associated with external links and/or access in a set or sets of computer instructions. In such an exemplary case, the external links can be, e.g., links to modules, libraries, sets of instructions, and/or binary files.

In some cases, the computer instructions associated with external links and/or external access can be represented in the binary code by a memory address directing to a set of computer instructions, wherein these computer instructions are not part of the received sequence of computer program instructions 130. In such cases, the effect on the program state resulting from the execution of the computer program instruction associated with the external link cannot be determined by the program state analyzing module 110, based solely on an analysis of the instructions, and, in some cases, cannot be replicated simply by executing the same instruction at a later time and/or as part of a separate execution flow.

In some embodiments, program instructions associated with internal links, in this exemplary case, can be a group or groups of computer program instructions or program blocks which are explicitly elaborated within the binary code. Thus, the effect on the program state resulting from the execution of the computer program instruction associated with the internal links can be determined based solely on an analysis of the instructions, and/or replicated simply by executing the same instruction at a later time and/or as part of a separate execution flow. In some cases, such an effect on the program state can be a change in the information of the program state.

In some embodiments, the program state analyzing module 110 can be configured to utilize a marking component 115 for marking the computer program instructions according to the effect thereof on the program state. For example, the program state analyzing module 110 can mark program instructions in the sequence of program instructions 130 to define them as either deterministic or non-deterministic. In some cases, the program state analyzing module 110 is configured to conduct the marking process such that the markings of the program instructions in the sequence of program instructions 130 can be recognized by the program executor 108, as elaborated below.

In some embodiments of the present invention, the marking component 115 may be configured to utilize an indexing component 117 for creating an index of the marked program instructions. In some cases, the indexing component 117 can be configured to associate the indexes to program blocks. For example, the indexing component 117 can insert indexes in a descending order or in an ascending order to the identified program instructions, or program blocks. The indexing component 117 can be configured to insert indexes which can be utilized when replaying the execution flow of the sequence of program instructions 130, as elaborated below. In some embodiments of the present invention, the process of inserting the indexes and/or markings may be configured to insert program code to the received sequence of program instructions 130.

In some embodiments, at step 215, the received sequence of program instructions can be executed. Such an execution can be controlled and managed by the computer system. Thus, the computer system can monitor, control resource allocations and trace the executing flow of at least some computer program instructions of the received sequence of computer program instructions. At the execution flow, the computer system can also recognize the marking and/or indexes associated with the computer program instructions and/or program blocks.

In some illustrative embodiments of the computing system, the computing system 100 can comprise a program executor 108 configured with instructions to execute the sequence of computer program instructions 130. In some embodiments of the present invention, the program executor 108 can also be configured to control the memory space utilized by the sequence of program instructions 130, such that the memory space and the processor registers, utilized by the sequence of program instructions 130, can be controlled and monitored by the program executor 108.

In some cases, the program executor 108 can also be configured to allocate the memory space and/or the processor registers, to the sequence of computer program instructions 130. For example, the program executor 108 can utilize simulation techniques wherein the sequence of computer program instructions 130 is loaded into a memory space located at the memory unit 106, such that control of that memory space and of the processor registers allocated to the execution of program instructions 130 is never passed to the sequence of program instructions 130. In such an exemplary case, the sequence of program instructions 130 may also receive from the program executor 108, a group of pseudo processor registers and pseudo memory addresses which can be controlled by the program executor 108. In some embodiments of the present invention, the control of the program executor 108 over the sequence of program instructions 130 is configured to allow the program executor 108 to monitor, control resource allocations, trace executing processes, and operate additional processes for the purpose of analyzing, changing, recording, and/or manipulating the sequence of computer program instructions 130.

The program executor 108 can also be configured to execute the sequence of program instructions 130. In some cases, the program executor 108 may be configured to execute the sequence of program instructions 130 after the analysis and defining processes. In some cases, the program executor 108 can also be configured to analyze the sequence of program instructions 130 and during the execution flow thereof, to identify program instructions as either deterministic or non-deterministic.

In some embodiments, at step 220, a selective memory tracing process of the program state can take place during the execution flow of the computer program instructions. The selective memory tracing process can be conducted by the computer system for the purpose of capturing snapshots of the program states. Thus, during the selective memory tracing process, program state data of the execution flow can be captured, based on marking and/or indexes associated with computer program instructions or block thereof. In some cases, such marking and/or indexes may indicate that the marked program instructions are non-deterministic. In some embodiments, the selective memory tracing process does not capture a full program state at execution points associated with non-deterministic instructions. For example, in some cases, only partial program state data is captured, wherein the captured data includes only those elements of the program state associated with and/or corresponding to the execution of non-deterministic instructions.

In some embodiments of the present invention, the selective memory tracing process can also copy the indexes and/or markings associated with the computer program instructions and/or program blocks. For example, in case an index (e.g., a numeric value) is associated with a specific computer program instruction, the index can be copied and associated with the corresponding program state's snapshot.

In some embodiments, a program executor 108 can also be configured to utilize the program state capturing component 112 for the purpose of capturing snapshots of the program state and associated execution points, of the executed sequence of program instructions 130.

In some cases, the program executor 108 can be configured to follow the execution flow of the sequence of program instructions 130 and call the program state capturing component 112 for capturing snapshots of the program state and associated execution points. Such snapshot capturing conducted by the program executor 108 can be a part of a selective memory tracing process, wherein a snapshot is captured in cases wherein the program executor 108 encounters markings indicating program instructions wherein the program state resulting from an execution thereof is non-deterministic.

For example, the program executor 108 executes the sequence of computer program instructions 130 and follows step by step the computer program instructions and/or the program blocks in the execution flow. In such an exemplary case, the program state capturing component 112 can be utilized to read the markings of the marked computer instructions, and, in case a computer instruction is marked as non-deterministic, the program state capturing component 112 captures a snapshot and an associated execution point of the program state.

In some cases, the program state capturing component 112 can be configured to store the captured snapshots, associated execution points, and the corresponding markings and/or indexes in the memory unit 106. In some cases, a storage device such as storage device 104 can also be utilized for the purpose of storing the captured snapshots, associated execution points, and the corresponding markings and/or indexes.

The computing system 100 can also be configured to utilize a storage device 104 which can be a computer readable storage medium. The storage device 104 can be a tangible device which can retain and store instructions for use by the processing unit 101. The storage device 104 may be, for example, but is not limited to, an electronic storage device, a magnetic storage device, an optical storage device, an electromagnetic storage device, a semiconductor storage device, or any suitable combination of the foregoing.

A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire. Rather, the computer readable storage medium is a non-transient (i.e., not-volatile) medium.

In some cases, the storage device 104 can store various programs and data. In one embodiment, storage device 104 may also include various programs and/or databases, such as but not limited to: a hypervisor, one or more operating systems (e.g., a host OS, various guest OSs), a file management program, a database management system, communication protocols, etc. (not shown) utilized by the computing system 100. Storage device 104 also includes various services, functions, and application programming interfaces (APIs) utilized by software applications that execute on computing system 100. In various embodiments, storage device 104 includes the data, source code, libraries, and binary files utilized by at least one of the following programs: Program executor 108, program state capturing component 112, program state analyzer 110, marking component 115, indexing component 117, and program instruction replay component 119. In some embodiments, storage device 104 may comprise two or more physically separate storage devices, e.g., an internal storage component, as well as an external storage such as an external drive, an SD card, cloud storage, network-attached storage (NAS), and/or similar or another portable and/or remote storage component or facility.

In some embodiments of the present invention, the process of capturing the program state snapshots and the snapshot writing process may be performed interactively and intermittently in an automated manner. For example, a first program state snapshot can be captured by the computer system and then, a snapshot writing process of the first program state snapshot may be performed before another program state snapshot (e.g., a second program state snapshot) is captured. In such a configuration of the computer system, the snapshot capturing process and the snapshot writing process can be managed together by the computer system. In some other cases, the computer system may perform the snapshot capturing process first, as mentioned in step 220 and upon completion of the selective snapshot capturing process, the snapshot writing process can take place.

At step 225, in some embodiments, the captured snapshots can be written to a trace log. In some cases, writing the snapshots to the trace log can also comprise writing the indexes and/or markings associated with the captured program state snapshots. For example, in case an index or a marking were copied at the selective memory tracing process as mentioned at step 220, the copied marking and/or index can be associated with the captured program state snapshot and be written into the trace log.

Accordingly, in some embodiments of the present invention, the program state capturing component 112 can be configured to write the program state snapshots to a trace log 125. In such cases, the program state capturing component 112 can be configured to create a representation of some or all captured program states. The representation can be then utilized for the replay of the execution flow, e.g., for debugging and/or archival purposes.

The trace log 125 can be used as a conventional data construct designed to represent the active program states during the execution flow. For example, the program state capturing component 112 can be configured to write the symbols, symbol information corresponding to specific instructions, object names, classes, interfaces, function names, variable names, and the like, in a character encoding format, i.e., ASCII, to the trace log 125. In such an exemplary case, the trace log 125 comprising the character encoding can be utilized to replay at least a part of the execution flow.

The trace log 125 can also be configured to receive copies (e.g., from the program state capturing component 112) of the markings, indexes and/or breakpoints associated with some of the computer program instructions, and/or program blocks. Such copies can allow replaying of at least a portion of the execution flow in a controlled and managed fashion.

For example, a computerized process can utilize the trace log 125 for replaying at least a portion of the execution flow, according to the data residing in the trace log 125. In such cases, the trace log 125 may comprise the call backs, the links, the return values, memory content, and/or any other information required for the replay of the execution flow. The trace log 125 can also comprise markings and/or indexes associated with some of the computer program instructions and/or program blocks, for the purpose of stopping and re-starting the replay of the execution flow at any desired point in the execution.

The trace log 125 can reside in a memory unit such as memory unit 120. In some cases, the memory unit can be controlled and managed by the computing system 100. In such cases, the memory unit 120 may be integrated with the computing hardware on which the computing system 100 is operated. For example, the memory unit 120 can comprise computer instructions, software applications, and the like, which can be operated by the processing unit 101.

In some other cases, the memory unit 120 can reside in a standalone and independent computing system. For example, the memory unit 120 can be part of a computerized device which allows access to one or more computing systems such as computing system 100. The computerized device can be a personal computer, a personal computer tablet, a server, and the like. In some cases, the access between the computerized system 100 and the computerized device operating and control the memory unit 120 may be conducted over telecommunications network. Such a telecommunications network may be the internet, local area network, wireless-based networks, and the like.

In some embodiment of the present invention, the trace log 125 can be embodied as a data structure (e.g., a database) and be utilized by a software application to represent the program state. In some cases, the trace log 125 can also comprise data, source code, libraries, and binary files utilized by other software application (e.g., the program state capturing component 112, or an execution replay component 119 as elaborated below).

In one exemplary case of possible embodiments of the present invention, the trace log 125 can be a data structure in the memory unit 120. In such an exemplary case, the program state capturing component 112 can be configured to use replication techniques for replicating the captured snapshots of the program state to the trace log 125. In such a case, the program state capturing component 112 can be configured to create a hardware state replication in a target memory unit (e.g., memory unit 120). The data captured at the program state capturing process can be replicated to the trace log 125, wherein the data stored in the trace log 125 is consistent at bit-level to the captured snapshots. The stored data in the trace log 125 can be utilized for replaying at least a part of the execution flow. The program state capturing component 112 can be also configured to copy markings, indexes and/or breakpoints associated with some of the computer program instructions, and/or program blocks. Such a copy can allow replaying of at least a portion of the execution flow with references to the marking, indexes and/or breakpoints.

In some embodiments, at step 230, the execution flow of the received sequence of computer program instructions ends. In some cases, an output indicating the completion of the execution flow can be performed. Such an output can be a print, an instance of a computer screen presentation, a digital file saved to a physical memory, a digital file sent to a remote server, and the like. In some cases, such an output can comprise some historical information with respect to the processes conducted by computer system.

Upon the completion of the selective tracing stage, the present disclosure may be configured for replaying at least a portion of the execution flow. Accordingly, the functional steps in the process for replaying an execution flow from a selective tracing, according to an embodiment, will now be described with reference to FIG. 2B.

At steps 235 and 240, a computer system may obtain a sequence of program instructions and access to a corresponding trace log. The obtained program instructions can be provided for the purpose of replaying the execution flow of the obtained sequence of program instructions. In some cases, the obtained sequence of program instructions can comprise markings, indexes and/or breakpoints associated with some of the program instructions and associated execution points, as aforementioned. In some embodiments, the sequence of program instructions can be obtained by a memory address directing to a location or locations in a computer readable storage medium. In some other cases, the sequence of program instructions can be obtained by a dedicated interface of a software application. In some embodiments of the present invention, the trace log can be obtained by a memory address directing to a location or locations in a computer readable storage medium, as aforementioned.

In some embodiments, at step 245, at least a part of the execution flow of the obtained sequence of program instructions is replayed in a controlled fashion. In some cases, such a replay of the execution flow can be initiated by allocating the obtained sequence of program instructions in a controlled memory location. The replay of the execution flow can be controlled by the computer system according to the corresponding markings, indexes and/or breakpoints.

In some cases, the execution replay component 119 can be configured to conduct a replay of at least a part of the execution flow, e.g., from a known and/or desired execution point. Thus, the execution replay component 119 can be configured to receive access to sequence of program instructions 130 and access to the corresponding trace log 125. The execution replay component 119 can also be configured to utilize the access to the trace log 125 and the access to the sequence of computer program instructions 130 for replaying at least a part of the execution flow originally resulted by the execution of the sequence of program instructions 130.

In some embodiments, execution replay component 119 can be configured to access and/or read the index and/or markings created at step 210 in FIG. 2A, and utilize trace log 125 for injecting a logged program state associated with an execution point of the execution flow.

The replay process conducted by the execution replay component 119 can be executed in an automated fashion, wherein execution replay component 119 replays the trace log 125 to inject the stored program state associated with an execution point of non-deterministic program instructions.

In some embodiments, the execution replay component 119 can be configured to follow the marking and the indexes associated with the program states of the sequence of computer program instructions 130. For example, the execution replay component 119 can be configured to replay an execution flow of at least a portion of the execution of the received sequence of computer program instructions 130, e.g., wherein the execution flow initiates in one marking or index value and ends up in another marking or index value.

In some embodiments of the present invention, the execution replay component 119 can be connected to an output device (not shown). The output device can be a computer hardware equipment which converts information into human-readable form. In some cases, the output device can be a printer, a computer screen, a physical memory, a remote server, and the like. In some cases, such an output device can be utilized by a person to monitor and follow the replay of at least a part of the execution flow.

In some embodiments, the replay from selective trace comprises different replay paths with respect to deterministic and non-deterministic instructions.

For example, in some embodiments, at step 250a, the replay flow may reach an execution point associated with a program instruction marked and/or indexed as ‘deterministic.’ In such cases, the replay may comprise simply executing the relevant program instruction. In some cases, upon the execution of the computer program instruction, the process of replaying the execution flow can move back to step 245 for the purpose of executing a next computer program instruction.

In some embodiments, at step 250b, the replay flow may reach an execution point associated with a program instruction marked and/or indexed as ‘non-deterministic.’ In some embodiments such cases, the replay may comprise inserting the corresponding program state from trace log 125 to the memory space of the execution flow. Thus, during a replay execution of the sequence of program instructions, a snapshot can be inserted at a relevant execution point associated with a non-deterministic program instruction.

In some cases, wherein indexes are associated with one or more computer program instructions, the indexes can be used to replay the execution flow form one index value to another index value. For example, the computer system can replay the execution flow from a computer program instruction associated with the index value 10 (ten) to the computer program instruction associated with the index value twenty (20).

In some embodiments, at optional step 255, the present disclosure may provide for outputting a current program state at a specified execution point. In some embodiments, such an output may be to a computer screen, printer, group or groups of memory addresses, and the like. In some embodiments, the outputted current program state may be used in the context of a debugger for debugging an application program. In some cases, the presentation of the program state values can comprise variable names, variable values, symbols in the symbol map, symbol information corresponding to specific instructions, object names, classes, interface names, function names, memory addresses, and the like.

In some embodiments, steps 235, 240, 245, 250a, and 250b may be repeated until at least a specified portion of the computer program instructions have been replayed. At step 260, the computer system completes the replay of the execution flow. In some cases, an output indicating the completion of the execution flow replay can be performed. Such an output can be a print, an instance of a computer screen presentation, a digital file saved to a physical memory, a digital file sent to a remote server, and the like. In some cases, such an output can comprise some historical information with respect to the processes conducted by computer system. The historical information can comprise values such as, command names, computer program instructions, program state values, variable values, indexes, breakpoint locations, and the like.

In some cases, the computer system may provide a control to an input device for receiving additional instructions. For example, the computer system can halt the execution flow and pass the control to a keyboard. In such a case, person operating the system can control the execution flow replay and thereby to continue the execution flow, to halt the replay, to go back to a specific computer program instruction, to go ahead to specific computer program instruction, and the like. In some cases, upon completion of the computer program instruction, the computer system may take the control of the execution flow for the purpose of executing the next computer program instruction, as aforementioned.

In some embodiments, the present disclosure provides for partial replay of a traced program, e.g., with respect only to a desired program instructions and/or groups of instructions. For example, in some embodiments, replay for debugging purposes may only be desired and/or required from a known execution point with respect to associated stack variables.

Accordingly, in some embodiments, the present disclosure may provide for partial replay using a set or sets of trailed indexes, also known as ‘breadcrumbs,’ installed during the sequence analysis stage (step 210 in FIG. 2A). in some embodiments, such breadcrumbs may be stored in trace log 125. For example, during the analysis stage, the program instructions may be mapped to indicate branch instructions, e.g., any instruction which causes execution to jump to a particular instruction elsewhere, such as conditional branch instructions, loop instructions, and/or subroutine calls. Accordingly, a ‘dependency lookup tree’ may be created, wherein each region may be mapped to a different region it is dependent on, and the location in the code where such a dependency exists. In some embodiments, the ‘breadcrumbs’ indications may later enable a retracing of the execution order through all previous conditional events.

In some embodiments, at the replay stage (step 245 in FIG. 2B), all ‘breadcrumbs’ are evaluated to identify, e.g., a list of breakpoints associated with method entries. Then, for each such entry, the present disclosure retraces the method until a breakpoint is reached, or the method reaches an end, wherein if a breakpoint is not reached, the retrace continues to the next method entry. Once a breakpoint is reached, the replay process then inserts the program state from those locations.

In some cases, the trailed indexes can be associated with each other for allowing replaying the execution flow according to a specific predefined path. For example, the trailed indexes can be utilized to control an execution flow wherein the execution flow is replayed through a sequence of a number of trailed indexes. In some cases, a map of trailed indexes can be prepared to allow a person controlling the execution flow replay. Such a set, or set of trailed indexes, can be used as a navigational aid at the process of replaying the execution flow. In some cases, the trailed indexes allow a person conducting the replay of the execution flow to keep track and maintain awareness of the program state according to the locations of the trailed indexes, during the replay of the execution flow.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire. Rather, the computer readable storage medium is a non-transient (i.e., not-volatile) medium.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A system comprising:
at least one hardware processor; and
a non-transitory computer-readable storage medium having stored thereon program code, the program code executable by the at least one hardware processor to:
receive a sequence of computer program instructions,
analyze the received sequence of program instructions to indicate execution points associated with non-deterministic program instructions,
execute the sequence of computer program instructions while capturing program state data, wherein said program state data is associated with at least some of said indicated execution points,
create a log indicating, with respect to each method entry in said execution, (a) an execution order of method entries preceding said method entry within said execution, and (b) memory locations and content referenced by said method entry, and
replay said execution from a user-selected breakpoint, by inserting said captured program state data at said associated execution points,
wherein, when during said replay, a current method requires a content of a memory location:
(i) execute, based on said log, a method preceding said current method which references said memory location, and
(ii) repeat (i) when said identified preceding method requires an unknown content of any memory location.

2. The system of claim 1, wherein said program capturing further comprises storing said captured program state data in an event log, and wherein said inserting comprises accessing said event log to retrieve said captured program state data.

3. The system of claim 1, wherein said analyzing further comprises indicating execution points associated with deterministic program instructions, and wherein said generating further comprises executing said execution points associated with said deterministic program instructions.

4. The system of claim 1, wherein said indicating further comprises creating an index of all said indications.

5. The system of claim 1, wherein said program state data comprises at least some of: content of at least some processor registers, memory content, variables utilized in the execution time, variable values, a symbol map, calls made by the execution, program stack content, and a program heap content.

6. The system of claim 1, wherein said identifying is reiterated in reverse order, based, at least on part, on said execution order indicated in said log.

7. The system of claim 6, wherein steps (i) and (ii) are repeated until said current method ends or until an execution of one of said preceding methods calls said current method.

8. A method comprising:
receiving a sequence of computer program instructions,
analyzing the received sequence of program instructions to indicate execution points associated with non-deterministic program instructions,
executing the sequence of computer program instructions while capturing program state data, wherein said program state data is associated with at least some of said indicated execution points,
creating a log indicating, with respect to each method entry in said execution, (a) an execution order of method entries preceding said method entry within said execution, and (b) memory locations and content referenced by said method entry, and
replaying said execution from a user--selected breakpoint, by inserting said captured program state data at said associated execution points,
wherein, when during said replaying, a current method requires a content of a memory location:
(i) executing, based on said log, a method preceding said current method which references said memory location, and
(ii) repeating (i) when said identified preceding method requires an unknown content of any memory location.

9. The method of claim 8, wherein said program capturing further comprises storing said captured program state data in an event log, and wherein said inserting comprises accessing said event log to retrieve said captured program state data.

10. The method of claim 8, wherein said analyzing further comprises indicating execution points associated with deterministic program instructions, and wherein said generating further comprises executing said execution points associated with deterministic program instructions.

11. The method of claim 8, wherein said indicating further comprises creating an index of all said indications.

12. The method of claim 8, wherein said program state data comprises at least some of: content of at least some processor registers, memory content, variables utilized in the execution time, variable values, a symbol map, calls made by the execution, program stack content, and a program heap content.

13. The method of claim 1, wherein said identifying is reiterated in reverse order, based, at least on part, on said execution order indicated in said log.

14. The method of claim 6, wherein steps (i) and (ii) are repeated until said current method ends or until an execution of one of said preceding methods calls said current method.

15. A computer program product comprising a non-transitory computer-readable storage medium having program code embodied therewith, the program code executable by at least one hardware processor to:
receive a sequence of computer program instructions,
analyze the received sequence of program instructions to indicate execution points associated with non-deterministic program instructions,
execute the sequence of computer program instructions while capturing program state data, wherein said program state data is associated with at least some of said indicated execution points,
create a log indicating, with respect to each method entry in said execution, (a) an execution order of method entries preceding said method entry within said execution, and (b) memory locations and content referenced by said method entry, and
replay said execution from a user-selected breakpoint, by inserting said captured program state data at said associated execution points,
wherein, when during said replay, a current method requires a content of a memory location:
(i) execute, based on said log, a method preceding said current method which references said memory location, and
(ii) repeat (i) when said identified preceding method requires an unknown content of any memory location.

16. The computer program product of claim 15, wherein said program capturing further comprises storing said captured program state data in an event log, and wherein said inserting comprises accessing said event log to retrieve said captured program state data.

17. The computer program product of claim 15, wherein said indicating further comprises creating an index of all said indications.

18. The computer program product of claim 15, wherein said program state data comprises at least some of: content of at least some processor registers, memory content, variables utilized in the execution time, variable values, a symbol map, calls made by the execution, program stack content, and a program heap content.

19. The computer program product of claim 15, wherein said identifying is reiterated in reverse order, based, at least on part, on said execution order indicated in said log.

20. The computer program product of claim 19, wherein steps (i) and (ii) are repeated until said current method ends or until an execution of one of said preceding methods calls said current method.
